(19) United States
(12) Patent Application Publication
(10) Pub. No.: US 2011/0117444 A1
(43) Pub. Date: May 19, 2011

(54) Electrolytic Solution and Lithium Battery Employing the Same

(75) Inventors: Fu-Ming Wang, Sijhih City (TW); Chang-Rung Yang, Taiping City (TW); Jing-Pin Pan, Hsinchu Hsien (TW); Hung-Chun Wu, Jhubei City (TW)

(73) Assignee: INDUSTRIAL TECHNOLOGY RESEARCH INSTITUTE, Hsinchu (TW)

(21) Appl. No.: 13/015,937

(22) Filed: Jan. 28, 2011

Related U.S. Application Data
(62) Division of application No. 12/036,341, filed on Feb. 25, 2008.

(30) Foreign Application Priority Data
Dec. 3, 2007 (TW) 96145902

(51) Int. Cl. H01M 10/056

(52) U.S. Cl. 429/328; 429/326; 429/331

(57) ABSTRACT

Disclosed is an electrolytic solution including an organic solvent, a lithium salt, and an additive. The additive includes maleimide compound and vinylene carbonate. The maleimide compound can be maleimide, bismaleimide, polymaleimide, polybismaleimide, maleimide-bismaleimide copolymer, or combinations thereof. The lithium battery employing the described electrolytic solution has a higher capacity of confirmation, higher cycle efficiency, and longer operational lifespan.

### CROSS REFERENCE TO RELATED APPLICATIONS

This application is a Divisional of pending U.S. patent application Ser. No. 12/036,341, filed on Feb. 25, 2008 and entitled “Electrolytic solution and lithium battery employing the same”, which claims priority of Taiwan Patent Application No. 096145902, filed on Dec. 3, 2007, the entirety of which is incorporated by reference herein.

### BACKGROUND OF THE INVENTION

1. Field of the Invention

The invention relates to an electrolytic solution, and in particular to a lithium battery employing the same.

2. Description of the Related Art

A lot of research regarding batteries as a driving energy source has been conducted to minimize battery weight for, and meet sophisticated technology requirements of, portable electronic devices such as video cameras, cellular phones and laptop computers. Particularly, the rechargeable lithium batteries have more energy density per unit weight as conventional lead storage batteries then nickel-cadmium batteries, nickel-hydro batteries and nickel-zinc batteries. In addition, they can provide quickly recharge.

A lithium battery cathode is typically composed of an active material including transition metal compounds such as LiNiO₂, LiCoO₂, LiMn₂O₄, LiFePO₄, LiNi.CO₁₋ₓO₂, Ni_{1-x-y}COₓMn_{y}O₂, or oxides containing the transition metal compounds and lithium. A lithium battery anode is typically composed of an active material including lithium metal, a lithium metal alloy or a carbonaceous material, and a graphite material. Electrolytes are categorized as liquid or solid electrolytes, according to electrolytic type. However, the liquid type electrolyte probably raises many safety problems including the potential danger of fire due to the leakage, outflow and destruction of batteries from evaporation. Hence, many researchers have suggested using solid electrolytes instead.

Many studies have particularly focused on solid polymer electrolytes, because solid polymer electrolytes are unlikely to leak electrolytic solution, and they are easy to process. Solid polymer electrolytes are further categorized into full solid types and gel types, where the full solid types do not contain an organic electrolytic solution, while the gel types do.

Generally, conventional aqueous electrolytic solutions are not suitable for lithium batteries mainly because they may react violently with lithium, which is used as an anode. Thus, an organic electrolytic solution in which a lithium salt is dissolved is used instead. The organic solvent may have high ionic conductivity, a high dielectric constant and low viscosity. But it is very difficult to obtain a single organic solvent having all three of these characteristics. As a result, a mixed solvent composed of an organic solvent having a high dielectric constant and an organic solvent having a low dielectric constant, or a mixed solvent composed of an organic solvent having a high dielectric constant and an organic solvent having low viscosity, is used as is an organic solvent for lithium batteries.

U.S. Pat. Nos. 6,114,070 and 6,048,637 disclose a mixed solvent composed of a linear carbonate and a cyclic carbonate, such as a mixture of dimethyl carbonate or diethyl carbonate, and ethylene carbonate or propylene carbonate, to improve the organic solvent's ionic conductivity. In general, the mixed solvent can be used only at 120° C. or lower, because if the temperature rises above 120° C., a battery using the mixed solvent may swell due to the gas generated from its vaporization.

Alternatively, utilization of 20% or greater of vinylene carbonate (VC) has been suggested as a main organic solvent of an organic electrolytic solution (U.S. Pat. Nos. 5,352,548, 5,712,059, and 5,714,281). When vinylene carbonate is used as the main solvent, however, charge/discharge characteristics may be degraded and high-rate characteristics may be decreased because the dielectric constant of vinylene carbonate is lower than ethylene carbonate, propylene carbonate and γ-butyrolactone.

U.S. Pat. No. 5,626,981 discloses a battery in which a surface electrolyte interface (SEI) is formed on the cathode surface during initial charge/discharge due to VC in an electrolytic solution, and U.S. Pat. No. 6,291,107 discloses a battery in which a polymer film is formed on the surface of a carbonaceous anode material by a monomer capable of electrochemical anionic polymerization (anionic polymerization monomer) during the initial charging.

U.S. Pat. No. 7,279,249 discloses using anionic polymerization monomer instead of VC to form SEI.

Accordingly, a novel electrolytic solution is called for improving lithium battery efficiency.

### SUMMARY OF THE INVENTION

The invention provides an electrolytic solution, comprising an organic solvent, a lithium salt, and an additive comprising a maleimide compound and a vinylene carbonate, wherein the maleimide compound comprises maleimide, bismaleimide, polymaleimide, polybismaleimide, maleimide-bismaleimide copolymer, or combinations thereof, wherein the bismaleimide is represented by formula (I):

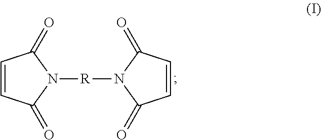

wherein R consists of —(CH₂)₆—, —(CH₂)₈—, —(CH₂)₁₂—, or

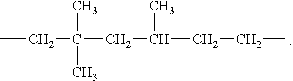

The invention also provides a lithium battery, comprising an anode, a cathode, a separator disposed between the anode and the cathode to define a reservoir region, the electrolytic solution filled in the reservoir region, and a sealed structure wrapped around the anode, the cathode, the separator, and the electrolytic solution.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is cross section of a lithium battery in one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

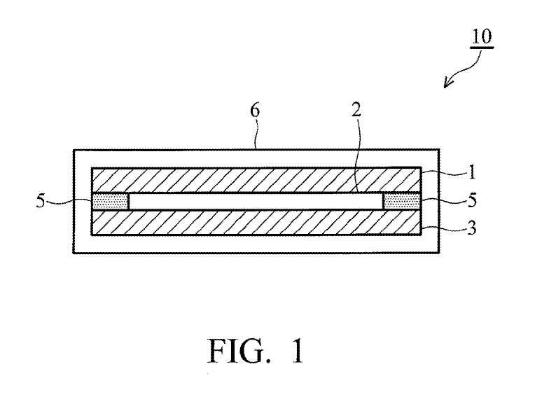

FIG. 1 is cross section of a lithium battery in one embodiment of the invention. In FIG. 1, a separator 5 disposed between the anode 1 and cathode 3 to define a reservoir region 2. The reservoir region 2 is filled with an electrolytic solution. In addition, the described structure is wrapped by a sealant structure 6.

The described anode 1 includes carbonaceous material or lithium alloy. The carbonaceous material can be carbon powder, graphite, carbon fiber, carbonanotube, or combinations thereof. In one embodiment, the carbonaceous material is the carbon powder with a diameter of 5 μm to 30 μm. The lithium alloy can be LiAl, LiZn, Li₃Bi, Li₃Cd, Li₃Sb, Li₄Si, Li_{4.4}Pb, Li_{4.4}Sn, LiC₆, Li₃FeN₂, Li_{2.6}CO_{0.4}N, Li_{2.6}Cu_{0.4}N, or combinations thereof. In addition, the anode 1 may further include metal oxide such as SnO, SnO₂, GeO, GeO₂, InO₂, In₂O₃, PbO, PbO₂, Pb₂O₃, Pb₃O₄, Ag₂O, AgO, Ag₂O₃, Sb₂O₃, Sb₂O₄, Sb₂O₅, ZnO, CoO, NiO, FeO, or combinations thereof.

The described cathode 3 includes a lithium mixed metal oxide such as LiMnO₂, LiMn₂O₄, LiCoO₂, Li₂Cr₂O₇, Li₂CrO4, LiNiO₂, LiFeO₂, LiNiₓCO₁₋ₓO₂, LiFePO₄, LiMn_{0.5}Ni_{0.5}O₂, LiMn_{1/3}CO_{1/3}Ni_{1/3}O₂, LiMc_{0.5}Mn_{1.5}O₄, or combinations thereof, wherein 0<x<1 and Mc is a divalent metal.

In one embodiment, the anode 1 and/or cathode 3 further includes a polymer binder to enhance the electrode adhesion mechanism strength. Suitable polymer binder includes poly(vinylidene fluoride) (hereinafter PVDF), styrene-butadiene rubber, polyamide, melamine resin, or combinations thereof.

The separator 5 is an insulation material, e.g. polyethylene (PE), polypropylene (PP), or multi-layered structure such as PE/PP/PE.

The major component of the described electrolytic solution is organic solvent, lithium salt, and additives. The organic solvent can be γ-butyrolactone (GBL), ethylene carbonate (EC), propylene carbonate (PC), diethyl carbonate (DEC), propyl acetate (PA), dimethyl carbonate (DMC), ethylmethyl carbonate EMC), or combinations thereof. The lithium salt can be LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or combinations thereof.

The additive is the critical point of the invention. In this invention, the combination of maleimide compound and vinylene carbonate (VC) is utilized as the additive to improve the capacity and the cycle lifespan of the battery. Suitable maleimide compound includes maleimide, bismaleimide, polymaleimide, polybismaleimide, maleimide-bismaleimide copolymer, or combinations thereof.

The described maleimide can be N-phenylmaleimide, N-(o-methylphenyl) maleimide, N-(m-methylphenyl) maleimide, N-(p-methylphenyl) maleimide, N-cyclohexylmaleimide, maleimide, maleimidophenol, maleimidobenzocyclobutene, phosphorous-containing maleimide, phosphonate-containing maleimide, siloxane-containing maleimide, N-(4-tetrahydropyranyl-oxyphenyl) maleimide, or 2,6-xylylmaleimide. In addition, barbituric acid (BTA) can be applied as an initiator to polymerize the double bond of the maleimide to form polymaleimide.

The described bismaleimide can be represented by formula (I):

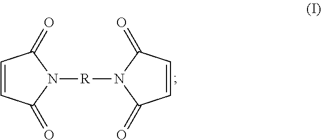

wherein R comprises —(CH₂)₂—, —(CH₂)₆—, —(CH₂)₈—, —(CH₂)₁₂—

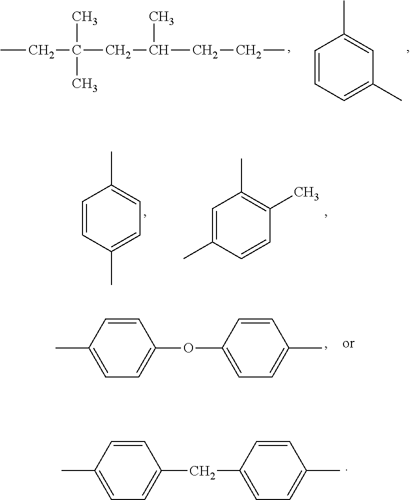

Similar to polymaleimide, BTA can be applied as the initiator to polymerize the double bond of the bismaleimide to form polybismaleimide. In one embodiment, the mixture of appropriate ratio of maleimide and bismaleimide is polymerized by utilizing the BTA as an initiator to form maleimide-bismaleimide copolymer.

In one embodiment, the electrolytic solution has a component ratio as below: 98.9 to 85 parts by weight of organic solvent, 1 to 10 parts by weight of lithium salt, and 0.1 to 5 parts by weight of additive. In the additive, maleimide compound and VC have a weight ratio of about 1:0 to 1:5. In Example 4, the maleimide compound is used alone in the lithium battery. In Examples 1-3, the maleimide compound and the VC process a coupling reaction to form a novel material. If the additive only includes VC without the maleimide compound, the pasty SEI of CH₃OCOL₁ and CH₃OCO₂Li is formed on the anode surface. On the other hand, if the additive only includes maleimide compound without VC, no pasty SEI is formed on the anode surface.

After 100 cycles of charge/discharge, the carbon sphere surface of the anode is analyzed by a scanning electron microscope (SEM). A plurality of cirrus SEI is tangled to each other on the carbon sphere surface. This phenomenon is not observed on the carbon sphere surface when the additive of the electrolytic solution only includes VC without maleimide, such that the specific tangled cirrus SEI is related to the additive components of the invention.

### COMPARATIVE EXAMPLE AND EXAMPLES

### Example 1

90 parts by weight of LiCoO₂, 5 parts by weight of PVDF, and 5 parts by weight of actylene black (conductive powder) were evenly dispersed in N-Methyl-2-pyrrolidone (NMP) to form a slurry. The slurry was then coated on the aluminum foil, dried, compressed, and cut to form a cathode.

95 parts by weight of graphite and 5 parts by weight of PVDF were dispersed in NMP to form a slurry. The slurry was then coated on the copper foil, dried, compressed, and cut to form an anode.

2 parts by volume of propylene carbonate, 3 parts by volume of ethylene carbonate, and 5 parts by volume of diethyl carbonate were mixed to be an organic solvent of the electrolytic solution. LiPF₆ was served as the lithium salt of the electrolytic solution, and LiPF₆ had a concentration of 1M. The bismaleimide and the VC were served as the additive of the electrolytic solution, and the bismaleimide was represented by Formula (II). The bismaleimide occupied 0.5 wt % of the electrolytic solution, and the VC occupied 2 wt % of the electrolytic solution, respectively.

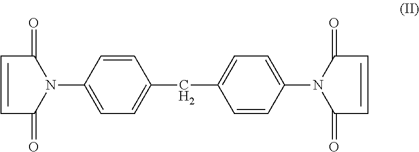

The cathode and the anode were separated by a separator of PP/PE/PP to form a reservoir region. The electrolytic solution was filled in the reservoir region. The described structure was wrapped and sealed by a sealant structure.

### Example 2

Similar to Example 1, the difference was that the bismaleimide represented by formula (II) of Example 1 was replaced by the bismaleimide represented by formula (III). Other conditions such as the manufacturing of the battery, the solvent of the electrolytic solution, the lithium salt, VC, and component ratio of bismaleimide and VC were similar to Example 1.

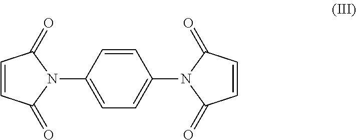

### Example 3

Similar to Example 1, the difference was that the bismaleimide represented by formula (II) of Example 1 was replaced by the bismaleimide represented by formula (IV). Other conditions such as the manufacturing of the battery, the solvent of the electrolytic solution, the lithium salt, VC, and component ratio of bismaleimide and VC were similar to Example 1.

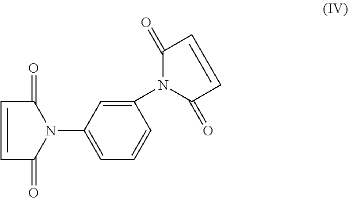

### Example 4

Similar to Example 3, the difference was that the additive only includes the bismaleimide represented by formula (IV) without VC. Other conditions such as the manufacturing of the battery, the solvent of the electrolytic solution, the lithium salt, and component ratio of bismaleimide were similar to Example 3.

### Comparative Example

Similar to Example 3, the difference was that the additive only includes VC without maleimide compound. Other conditions such as the manufacturing of the battery, the solvent of the electrolytic solution, the lithium salt, VC, and component ratio of VC were similar to Example 1.

Electric Measurement

A. Battery Capacity

The batteries of Examples 1-4 and the Comparative example were charged/discharged by a constant current. First, the batteries were charged to 4.2V by 0.2 mA/cm² current until the current was less than or equal to 0.1 mA/cm². Next, the batteries were discharged by 0.2 mA/cm² current to a discharge cut-off voltage 2.75V. The battery capacity (milliamp hours, mAh) and battery charge/discharge efficiency (%) of Examples 1-4 were tabulated as in Table 1.

B. Charge/Discharge Cycle Test

The batteries of Examples 1-4 and the Comparative example were charged/discharged by constant current. First, the batteries were charged to 4.2V by 1 mA/cm² current until the current was less than or equal to 0.1 mA/cm². Next, the batteries were discharged by 1 mA/cm² current to a discharge cut-off voltage 2.75V. Repeating the described charge/discharge 200 times, and the batteries were charged to 4.2V by 3 mA/cm² current until the current was less than or equal to 0.1 mA/cm². Subsequently, the batteries were discharged by 3 mA/cm² current to a discharge cut-off voltage 2.75V. Repeating the described charge/discharge 20 times. The battery capacity (mAh) and battery charge/discharge efficiency (%) after 200^{th} charge/discharge of Examples 1-4 were tabulated as in Table 1.

TABLE 1

| | (After 1 time | | (After 200 times | |
|---|---|---|---|---|
| | charge/discharge) | | charge/discharge) | |
| | | The battery | | The battery |
| | The battery | charge/ | The battery | charge/ |
| | capacity | discharge | capacity | discharge |
| Battery | (mAh) | efficiency (%) | (mAh) | efficiency |
| Example 1 | 1070 | 98.1 | 990 | 92.5 |
| Example 2 | 1080 | 98.2 | 1005 | 93.1 |
| Example 3 | 1060 | 98.1 | 980 | 92.5 |
| Example 4 | 1065 | 97.5 | Not detected | Not detected |
| Comparative | 1030 | 92.5 | 860 | 83.5 |
| Example | | | | |

Compared to Comparative Example 1, the battery capacities of the Examples were enhanced by about 5-10%. After 200 times cycle of charge/discharge, the battery efficiencies of the Examples were enhanced 10-15% compared to that of the Comparative example. The described data shows that maleimide compound accompanying VC to be the additive of the electrolytic solution in the invention may efficiently improve battery capacity and battery charge/discharge efficiency.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrolytic solution, comprising:
an organic solvent;
a lithium salt; and
an additive comprising a maleimide compound and a vinylene carbonate;
wherein the maleimide compound comprises maleimide, bismaleimide, polymaleimide, polybismaleimide, maleimide-bismaleimide copolymer, or combinations thereof;
wherein the bismaleimide is represented by formula (I): 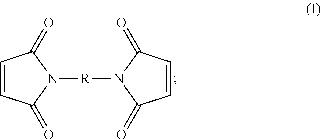
wherein R consists of —(CH₂)₆—, —(CH₂)₈—, —(CH₂)₁₂—, or

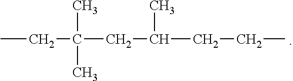

2. The electrolytic solution as claimed in claim 1, wherein the organic solvent comprises γ-butyrolactone, ethylene carbonate, propylene carbonate, diethyl carbonate, propyl acetate, dimethyl carbonate, ethylmethyl carbonate, or combinations thereof.

3. The electrolytic solution as claimed in claim 1, wherein the lithium salt comprises LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or combinations thereof.

4. The electrolytic solution as claimed in claim 1, wherein the maleimide comprises N-phenylmaleimide, N-(o-methylphenyl) maleimide, N-(m-methylphenyl) maleimide, N-(p-methylphenyl) maleimide, N-cyclohexylmaleimide, maleimide, maleimidophenol, maleimidobenzocyclobutene, phosphorous-containing maleimide, phosphonate-containing maleimide, siloxane-containing maleimide, N-(4-tetrahydropyranyl-oxyphenyl) maleimide, or 2,6-xylylmaleimide.

5. A lithium battery, comprising:
an anode;
a cathode;
a separator disposed between the anode and the cathode to define a reservoir region;
the electrolytic solution as claimed in claim 1 filled in the reservoir region; and
a sealant structure wrapped around the anode, the cathode, the separator, and the electrolytic solution.

6. The lithium battery as claimed in claim 5, wherein the anode comprises carbonaceous material or lithium alloy.

7. The lithium battery as claimed in claim 6, wherein the carbonaceous material comprises carbon powder, graphite, carbon fiber, carbonanotube, or combinations thereof.

8. The lithium battery as claimed in claim 6, wherein the lithium alloy comprises LiAl, LiZn, Li₃Bi, Li₃Cd, Li₃Sb, Li₄Si, Li_{4.4}Pb, Li_{4.4}Sn, LiC₆, Li₃FeN_{2.6}CO_{0.4}N, Li_{2.6}Cuₒ₄N, or combinations thereof.

9. The lithium battery as claimed in claim 6, wherein the anode further comprises a metal oxide, and the metal oxide comprises SnO, SnO₂, GeO, GeO₂, InO₂, In₂O₃, PbO, PbO₂, Pb₂O₃, Pb₃O₄, Ag₂O, AgO, Ag₂O₃, Sb₂O₃, Sb₂O₄, Sb₂O₅, ZnO, CoO, NiO, FeO, or combinations thereof.

10. The lithium battery as claimed in claim 6, wherein the anode further poly(vinylidene fluoride), styrene-butadiene rubber, polyamide, melamine resin, or combinations thereof.

11. The lithium battery as claimed in claim 5, wherein the cathode comprises a lithium mixed metal oxide, and the lithium mixed metal comprises LiMnO₂, LiMn₂O₄, LiCoO₂, Li₂Cr₂O₇, Li₂CrO4, LiNiO₂, LiFeO₂, LiNiₓCO₁₋ₓO₂, LiFePO₄, LiMn_{0.5}Ni_{0.5}O₂, LiMn_{1/3}CO_{1/3}Ni_{1/3}O₂, LiMc_{0.5}Mn_{1.5}O₄, or combinations thereof, wherein 0<x<1 and Mc is a divalent metal.

12. The lithium battery as claimed in claim 11, wherein the cathode further comprises a polymer binder, and the polymer binder comprises poly(vinylidene fluoride), styrene-butadiene rubber, polyamide, melamine resin, or combinations thereof.

13. The lithium battery as claimed in claim 5, wherein the separator comprises polyethylene, polypropylene, or combinations thereof.
